(19) United States
(12) Patent Application Publication
(10) Pub. No.: US 2010/0135868 A1
(43) Pub. Date: Jun. 3, 2010

(54) SOFT X-RAY PHOTOIONIZATION CHARGER

(75) Inventors: Kang-Ho Ahn, Seoul (KR); Yong-Taek Kwon, Icheon-si (KR); Jeong-Suk Choi, Yongin-si (KR); Jin-Wook Yoon, Icheon-si (KR); Dae-Seong Kim, Icheon-si (KR); Yong-Min Kim, Seoul (KR)

Correspondence Address: RABIN & Berdo, PC, 1101 14TH STREET, NW, SUITE 500, WASHINGTON, DC, 20005, US

(73) Assignee: HYUNDAI CALIBRATION & CERTIFICATION TECHNOLOGIES CO., LTD, Gyeonggi-do (KR)

(21) Appl. No.: 12/598,893

(22) PCT Filed: May 8, 2008
(86) PCT No.: PCT/KR08/02576

§ 371 Date: Nov. 4, 2009

(30) Foreign Application Priority Data
May 15, 2007 (KR) 10-2007-0047230

(51) Int. Cl. H05F 1/00

(52) U.S. Cl. 422/186.04

(57) ABSTRACT

A soft X-ray photoionization charger includes a housing having a chamber and an aperture formed on one side surface of the housing and joined to the chamber. The chamber forms a flow path of an aerosol containing particles. A photoionizer is fixed to the aperture of the housing. The photoionizer includes a head for irradiating soft X-rays into the chamber to neutralize the particles. A transparent window is mounted between the chamber and the head. The transparent window is made of a material permitting passage of the soft X-rays. The photoionization charger further includes a soft support ring arranged around the transparent window and tightly fitted to the aperture.

### TECHNICAL FIELD

The present invention relates to a soft X-ray photoionization charger and, more particularly, to a soft X-ray photoionization charger for neutralizing particles contained in an aerosol by irradiating soft X-rays.

### BACKGROUND ART

In a variety of fields such as a semiconductor, a TFT-LCD (Thin Film Transistor-Liquid Crystal Display), a PDP (Plasma Display Panel), medical chemistry, biology, genetic engineering and the like, research and development are extensively made in order to minimize generation of particles that adversely affect a process. For example, particles generated in a semiconductor manufacturing process become a cause of changing the characteristics of a semiconductor and eventually reducing the productivity thereof. In the semiconductor manufacturing process, therefore, particles are monitored in an effort to analyze the cause of generation of the particles and prevent generation thereof. The particle monitoring is conducted by two methods, i.e., a test wafer monitoring method and an in-situ particle monitoring method.

A scanning mobility particle sizer is used in monitoring an aerosol or a gas with the in-situ particle monitoring method. The scanning mobility particle sizer is comprised of a neutralizer, a differential mobility analyzer and a condensation nucleus counter. Particles in an aerosol are bipolar-charged by the neutralizer and then supplied to the differential mobility analyzer. The voltage in the differential mobility analyzer varies over time and the particles passing through the differential mobility analyzer are influenced by time-dependently varying electric fields. Therefore, particles having identical electric mobility are extracted by the differential mobility analyzer. The condensation nucleus counter measures the number of particles while exponentially changing the voltage of the differential mobility analyzer over time. The number of particles thus measured is divided into particle numbers depending on time intervals. The particle concentrations in the respective time intervals with respect to an average electric mobility are found. Then, the distribution of particles is found using the data of particle concentrations.

The neutralizer uses one of highly useful radioisotopes, e.g., ²¹⁴Am, ⁸⁵Kr or ²¹⁰Po, in order to obtain the Maxwell-Boltmann particle distribution, which is sometimes called an equilibrium charge distribution. With a view to minimize any harmful influence possibly caused by radioactive rays, the use of radioisotopes is strictly controlled by laws and regulations. This means that many difficulties are encountered in using the radioisotopes. Another problem is that a large amount of costs and an increased number of technical experts are required in managing and controlling the radioisotopes and in treating radioactive wastes.

Meanwhile, soft X-rays exhibit high ionizing energy and have an ability to directly ionize the molecules and particle contained in an aerosol. The soft X-rays are weaker in intensity than typical X-rays, easy to handle and capable of generating ions in a larger quantity than generated by radioisotopes. Therefore, the soft X-rays show superior performance in neutralizing particles.

U.S. Patent Publication No. 2005/0180543A1 discloses a technique of neutralizing particles by use of soft X-ray photoionization. With the technique taught in this publication, a photoionizer has a head exposed within a chamber. For that reason, there is a problem in that a large quantity of nanometer size particles are generated from the wall surface of the chamber by the soft X-rays irradiated from the head. The particles generated from the wall surface of the chamber reduce reliability in measurement.

### DISCLOSURE OF INVENTION

### Technical Problem

In view of the above-noted and other problems inherent in the prior art, it is an object of the present invention to provide a soft X-ray photoionization charger capable of preventing generation of particles from the wall surface of a chamber by provision of a transparent window between the chamber of a housing forming an aerosol flow path and the head of a photoionizer.

Another object of the present invention is to provide a soft X-ray photoionization charger that can be used with ease.

### Technical Solution

With these objects in view, the present invention provides a soft X-ray photoionization charger comprising: a housing having a chamber and an aperture formed on one side surface of the housing and joined to the chamber, the chamber forming a flow path of an aerosol containing particles; a photoionizer fixed to the aperture of the housing, the photoionizer including a head for irradiating soft X-rays into the chamber to neutralize the particles; and a transparent window mounted between the chamber and the head, the transparent window being made of a material permitting passage of the soft X-rays.

The soft X-ray photoionization charger further comprises a soft support ring arranged around the transparent window and tightly fitted to the aperture. The transparent window is made of one member selected from the group consisting of slice glass and slice mica.

### ADVANTAGEOUS EFFECTS

In accordance with the soft X-ray photoionization charger of the present invention, a transparent window is provided between the chamber of a housing forming an aerosol flow path and the head of a photoionizer. Therefore, it is possible to prevent generation of particles from the wall surface of the chamber. Furthermore, the present soft X-ray photoionization charger is convenient to use.

### BRIEF DESCRIPTION OF THE DRAWINGS

The above and other objects and features of the present invention will become apparent from the following description of a preferred embodiment, given in conjunction with the accompanying drawings.

FIG. 1 is an exploded perspective view showing a soft X-ray photoionization charger in accordance with the present invention.

FIG. 2 is a section view of the soft X-ray photoionization charger in accordance with the present invention.

FIG. 3 is a partially enlarged section view illustrating a transparent window and a support ring employed in the present soft X-ray photoionization charger.

FIG. 4 is a graph plotting the relationship between a particle size and a particle concentration found through experiments, which are conducted to prove the performance of the present soft X-ray photoionization charger.

### BEST MODE FOR CARRYING OUT THE INVENTION

A preferred embodiment of a soft X-ray photoionization charger in accordance with the present invention will now be described in detail with reference to the accompanying drawings.

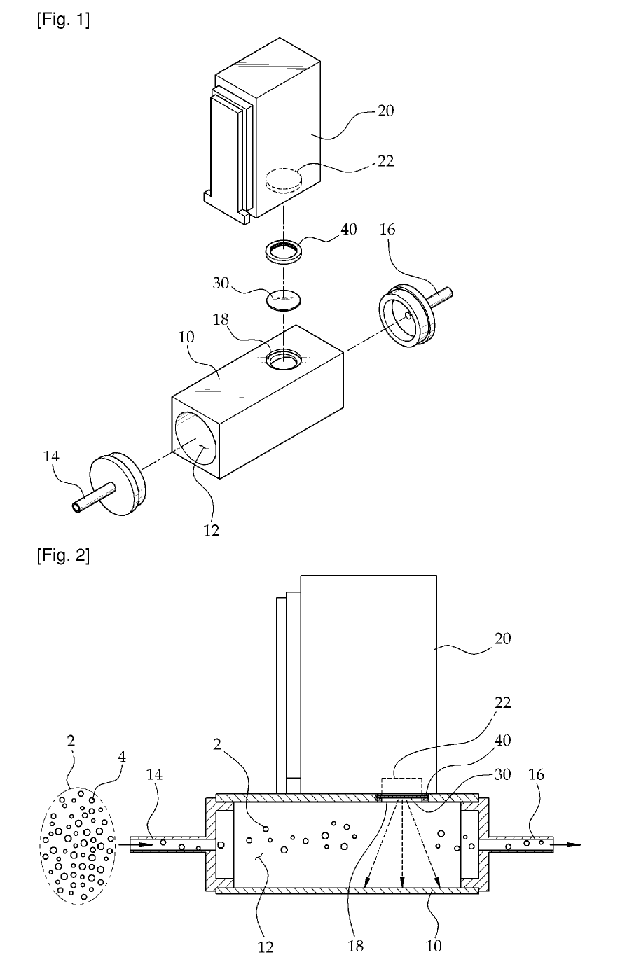

Referring first to FIGS. 1 and 2, the present soft X-ray photoionization charger is designed to neutralize a large quantity of particles 4 contained in an aerosol 2 or a gas so that they can have the Maxwell-Boltmann particle distribution.

The soft X-ray photoionization charger includes a housing 10 that forms a flow path of the aerosol 2. An inlet tube 14 and an outlet tube 16 for introducing and discharging an aerosol 2 therethrough are connected to a chamber 12 of the housing 10. Mounted to the outlet tube 16 are a main flow controller for controlling the flow rate of the aerosol 2, an ion counter for measuring the size and concentration of particles 4, an air pump or a vacuum pump for sucking up the aerosol 2 and a filter for filtering the particles 4.

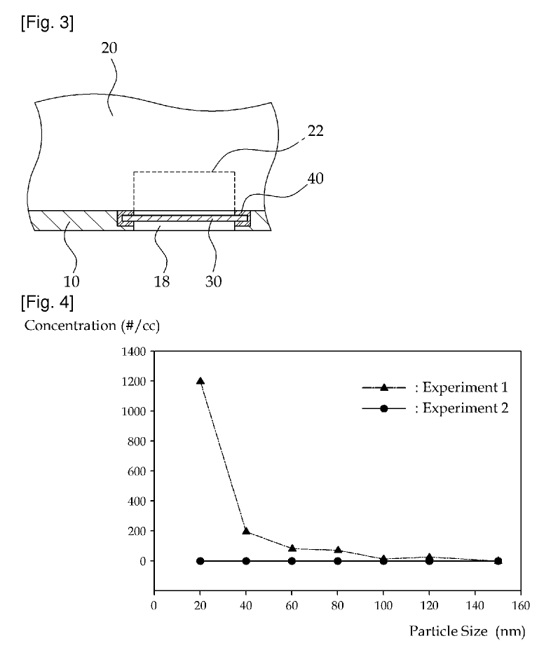

Referring to FIGS. 1 through 3, the housing 10 has an aperture 18 formed on one side of the outer surface thereof and joined to the chamber 12. A head 22 of a photoionizer 20 for generating soft X-rays is attached to the aperture 18 of the housing 10. A transparent window 30 through which the soft X-rays pass is arranged between the chamber 12 and the head 22.

A support ring 40 made of a soft material, e.g., plastic or synthetic resin, is arranged in the peripheral edge of the transparent window 30. The support ring 40 makes close contact with the inner surface of the aperture 18 to maintain air-tightness and also to prevent damage of the transparent window 30, which would otherwise be caused by shocks. The support ring 40 may be formed of an O-ring, a seal member or the like.

The transparent window 30 is made of a hard material, e.g., slice glass or slice mica. Typically, the slice glass has a hardness of 4.5 to 5.5 and the slice mica has a hardness of 2.5 to 4. If the hardness of the transparent window 30 is smaller than 2.5, the transparent window 30 is easily broken by external shocks and therefore is unsuitable for use in the soft X-ray photoionization charger. The slice glass or the slice mica has a thickness of preferably 0.3 mm or less and more preferably 0.2 mm or less. If the thickness of the slice glass or the slice mica exceeds 0.3 mm, the slice glass or the slice mica shows sharp reduction in the transmissivity of the soft X-rays, thereby rendering the transparent window 30 unsuitable for use in the soft X-ray photoionization charger.

As shown in FIG. 2, soft X-rays with a wavelength of 1.2 to 1.5 A are generated from the head 22 as the photoionizer 20 of the present soft X-ray photoionization charger begins to operate. The soft X-rays are irradiated into the chamber 12 through the transparent window 30 and the aperture 18 of the housing 10. The aerosol 2 is supplied to the chamber 12 through the inlet tube 14 of the housing 10. The aerosol 2 thus supplied flows along the chamber 12 before it is discharged through the outlet tube 16. The particles 4 contained in the aerosol 2 are neutralized by the soft X-rays so that they can have the Maxwell-Boltmann particle distribution. Therefore, it becomes possible to accurately measure the size and concentration of the particles 4 by use of the ion counter, the differential mobility analyzer, the condensation nucleus counter and so forth.

Experiments 1 and 2 were conducted to evaluate the performance of the present soft X-ray photoionization charger. In Experiments 1 and 2, soft X-rays with a wavelength of 1.2 to 1.5 A were generated and irradiated into the chamber 12 by operating the photoionizer 20. A clean air from which particles are removed was supplied into the chamber 12 through the inlet tube 14 at a flow rate of 1 liter per minute. Experiment 1 was carried out by fitting the transparent window 30 made of 0.2 mm-thick slice mica between the chamber 12 and the head 22. In Experiment 2, no transparent window was arranged between the chamber 12 and the head 22, thus allowing the head 22 to be directly exposed to the chamber 12.

In Experiments 1 and 2, the concentration (#/cc) of the particles 4 was measured on a particle size (nm) basis by use of the ion counter mounted to the outlet tube 16, the results of which are shown in FIG. 4. It can be seen in FIG. 4 that no particle was generated in Experiment 1 and further that particles having a size of 40 nm or less were generated in a large quantity in case of Experiment 2. These particles are generated from the wall surface of the housing 10 as a result of irradiation of the soft X-rays. The particles generated from the wall surface of the housing 10 become a cause of errors in measuring process particles of nanometer size. As can be noted from the results of Experiment 1, the transparent window 30 made of slice mica and arranged between the chamber 12 and the head 22 prevents generation of particles which would otherwise be generated from the wall surface of the housing 10. Therefore, the present soft X-ray photoionization charger can be used as a neutralizer in the scanning mobility particle sizer or the like. In case the transparent window 30 is made of slice glass and arranged between the chamber 12 and the head 22, it was proven that no particle is generated from the wall surface of the housing 10.

The embodiment set forth hereinabove have been presented for illustrative purpose only and, therefore, the present invention is not limited to this embodiment. It will be understood by those skilled in the art that various changes and modifications may be made without departing from the scope of the invention defined in the claims.

### INDUSTRIAL APPLICABILITY

With the present soft X-ray photoionization charger described above, no particle is generated from the wall surface of the housing, because the transparent window is arranged between the chamber of the housing and the head of the photoionizer. This makes it possible to enhance reliability and reproducibility of particle measurement. In addition, the present soft X-ray photoionization charger is safe and easy to manage while keeping the aerosol neutralizing performance in tact, as compared to a case where radioisotopes are used for that purpose. Therefore, the present soft X-ray photoionization charger can be conveniently used in an apparatus for performing an in-situ particle monitoring method or other equipments.

1. A soft X-ray photoionization charger comprising:
a housing having a chamber and an aperture formed on one side surface of the housing and joined to the chamber, the chamber forming a flow path of an aerosol containing particles;
a photoionizer fixed to the aperture of the housing, the photoionizer including a head for irradiating soft X-rays into the chamber to neutralize the particles; and
a transparent window mounted between the chamber and the head, the transparent window being made of a material permitting passage of the soft X-rays.

2. The soft X-ray photoionization charger as recited in claim 1, further comprising a soft support ring arranged around the transparent window and tightly fitted to the aperture.

3. The soft X-ray photoionization charger as recited in claim 1, wherein the transparent window has a hardness of 2.5 or more and a thickness of 0.3 mm or less.

4. The soft X-ray photoionization charger as recited in claim 3, wherein the transparent window is made of one member selected from the group consisting of slice glass and slice mica.
